(19) United States
(12) Patent Application Publication
(10) Pub. No.: US 2003/0140073 A1
(43) Pub. Date: Jul. 24, 2003

(54) Data table input and real-time dynamic display on a handheld device

(76) Inventor: Todd Wostrel, Plano, TX (US)

Correspondence Address: TEXAS INSTRUMENTS INCORPORATED, P O BOX 655474, M/S 3999, DALLAS, TX, 75265

(21) Appl. No.: 10/025,807

(22) Filed: Dec. 18, 2001

(51) Int. Cl. G06F 15/04

(52) U.S. Cl. 708/130

(57) ABSTRACT

An improved user interface having a data table for input and display of real-time data on a handheld device. The invention is applicable and useful or other computer devices with a limited screen display such as personal data assistance and other hand held electronic devices. An embodiment of the present invention is an application program on a graphing calculator or other computer, which allows the user to display and modify a two dimensional grid of real-time data. Similarly, other embodiments include the same user interface functionality in a ROM software application package that is executed on a graphing calculator or other handheld device.

### TECHNICAL FIELD OF THE INVENTION

This invention relates to hand-held electronic computing devices and software on those devices, and more particularly to a calculator that includes a user interface having a data table for input and display of real-time data on a handheld device or other device with a limited display screen.

### BACKGROUND OF THE INVENTION

Electronic calculators have become a common tool for teaching students mathematics. In particular, the advantages of graphing calculators are being utilized in the classroom. Graphing calculators are characterized by a larger screen, which permits the entry of mathematical expressions in a logical format. They also permit graph displays and table displays. They have sophisticated programming capability. They often permit data transmission to other computing devices, directly or via a data storage medium, as well as data collection via various interface protocols.

Particular calculator models are often designed for particular educational levels. For example, a calculator for middle school students might have less advanced features than one designed for older students. However, regardless of the level for which a calculator is designed, a continual goal in designing them is to provide a logical and easy to use interface. Another goal of the user interface is to assist the teacher in instructing students in the classroom environment.

### SUMMARY OF THE INVENTION

The present invention seeks to improve the user interface for a real-time display application. The disclosed embodiment is a user interface having a data table for input and display of real-time data on a handheld device. The invention is applicable and useful or other computer devices with a limited screen display such as personal data assistance and other hand held electronic devices. The invention introduces an improved user interface to allow the user to enter real-time data and observe the results.

An embodiment of the present invention is an application program on a graphing calculator or other computer, which allows the user to display and modify a two dimensional grid of real-time data. Similarly, other embodiments include the same user interface functionality in a ROM software application package that is executed on a graphing calculator or other handheld device. The calculator in the present invention may otherwise be a conventional graphing calculator.

### BRIEF DESCRIPTION OF THE DRAWINGS

FIG. 1 illustrates the front panel of a prior art calculator 10 which incorporates the invention.

FIG. 2 illustrates the basic screen of a real-time grid display on a handheld device according to the present invention.

FIG. 3 illustrates the screen display of a simulation lab having a real-time grid display on a handheld device according to the present invention.

FIG. 4 illustrates cell (1,1,0) for the heat transfer simulation lab according to the present invention.

### DETAILED DESCRIPTION OF THE INVENTION

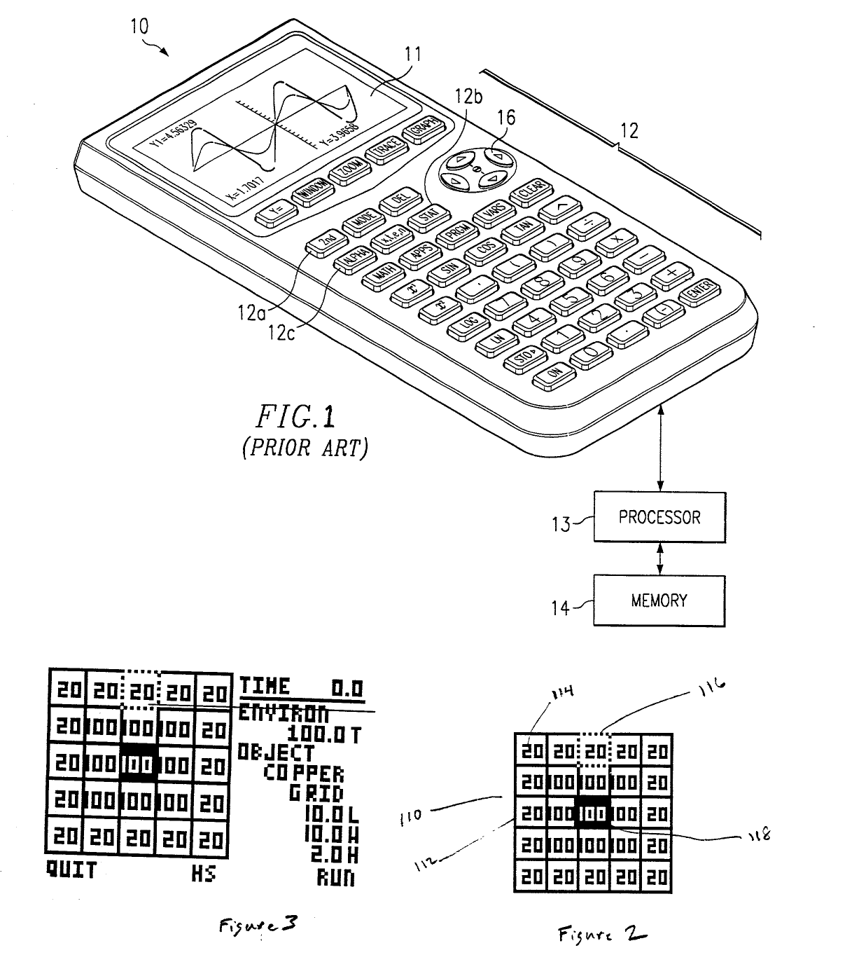

FIG. 1 illustrates the front panel of a calculator 10, which incorporates the features of the present invention. Calculator 10 is described herein in terms of particular software and hardware features of the TI-83+, a commercially available graphing calculator manufactured by Texas Instruments Incorporated. Apart from the features of the present invention, many of the features of calculator 10 described herein are typical of graphing calculators, while other features are unique to the TI-83+“family” of TI calculators. The use of the TI-83+ is for purposes of description, and does not limit the invention. The features that are the subject of the present invention could be incorporated into other calculators that provide graphical displays, or they could be incorporated into other computer based teaching tools and handheld computers.

In FIG. 4, the screen 11 of calculator 10 has a “graphical display”, as that term is used herein. In addition to the ability to draw graphical displays of various types, some of the software features of calculator 10 include software applications loading and storage, and keystroke programming. It also permits data collection, display and analysis.

Various hardware features include a large pixel screen 11 which is 64×94 pixels. A keypad 12 has various keys for data and command entry, some of which are used to implement the invention and are described herein. The calculator includes a processor 13 connected to a memory unit 14 having a 32K byte RAM and 512K byte application space. Other features are an I/O port for data linking, and a unit-to-unit link cable connection capability.

As is typical of calculators, calculator 10 has a secondary function key, 2nd key 12a, which permits other keys to have two functions. For example, by pressing 2nd key 12a and then STAT/LIST key 12b, the calculator performs the LIST function. For simplicity of explanation herein, a key having two functions is referred to in terms of the function appropriate for the context, i.e., when discussing the LIST function, the STAT/LIST key 12b is referred to as the LIST key 12b. Similarly, calculator 10 has an Alpha key 12c, which when depressed makes the other keys subsequently depressed to input an alpha character.

FIG. 2 illustrates an example of the screen display of an embodiment of the present invention. This screen display is for the calculator illustrated in FIG. 1 while running an application program stored in memory 14 by processor 13.

The present invention seeks to improve the user interface for a real-time display application. The disclosed embodiment is a user interface having a data table for input and display of real-time data on a handheld device. The invention is applicable and useful for other computer devices with a limited screen display such as personal data assistants or other hand held electronic devices. The invention introduces an improved user interface to allow the user to enter real-time data and observe the results on a limited graphics display.

An embodiment of the present invention is an application program on a graphing calculator or other computer, which allows the user to display and modify a two dimensional grid of real-time data. The display 110 includes rows and columns of cells 112. The cells have a number displayed 114, which reflects a common property under analysis by the computer program. These properties could be physical quantities, qualities or properties of nature such as temperature, pressure, population, heat, stress, etc. The application software provides a real-time simulation display of one of these properties and how it changes in response to surrounding cells according to an algorithm set by the user. In more sophisticated displays, properties may be displayed with multiple colors. However, in some limited screen devices such as calculators, display of a grid of numbers gives a similar visual effect.

In this embodiment, the status of individual cells is demonstrated to the user in a graphical way. FIG. 2 shows the location of the cursor 116 using a hatched cell boundary. Similarly, other types of graphics could be used to identify the cursor to the user. Further, the status of a locked cell, one that is forced to a fixed value by the user for the simulation, is shown in FIG. 2 as a inverse video number 118 in the cell.

An embodiment of the present invention is a heat transfer simulation lab for student use on a hand-held graphing calculator. The lab allows the user to model the effect of heat transfer on various objects of various materials. The real time nature of the display allows the user to observe the results of the heat transfer and conduct multiple scenarios by modifying the initial temperatures of the cells and setting fixed temperatures of individual cells and then restarting the simulation.

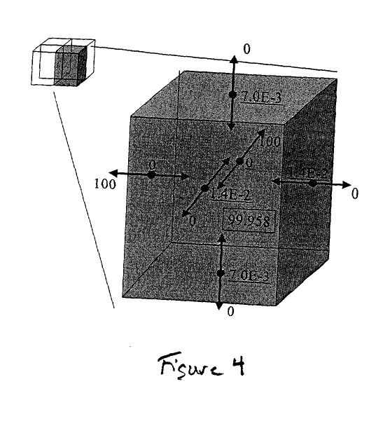

FIG. 3 shows a screen display for the heat transfer simulation lab according to another embodiment of the present invention. The grid of cells is as described above with reference to FIG. 2. Other simulation parameters are displayed to the right and bottom of the grid as shown in FIG. 3. The user uses the direction keys to move the cursor and select one of the parameters to modify. The selected parameter will be indicated by an arrow in the text portion of the display, or by a dashed cell exterior for a cell as described above. The + and − keys can be used to decrement or increment the units. If the cursor is on a cell, a function key can toggle the cell to be a heat source and displayed in reverse video.

The heat transfer simulation lab is further described in the following paragraphs.

The Heat lab models heat transfer for grid objects using Newton's Law of Cooling. The grid object is modeled as a 3d object, with cells located by (x, y, z) coordinates as shown in FIG. 4. The cells range from (0, 0, 0) to (X, Y, Z). The temperature at a specific cell at a time t=0 is T₀, the original cell temperature. For time t>0, T(x,y,z,t), is determined as follows

T(x, y, z, t)=Tₐ (0.1)

if x<0 or y<0 or z<0 or x>=X or y>=Y or z>=Z, which states that the temperature outside of the grid object is the ambient temperature (Tₐ). Otherwise, the temperature is defined as

$$\begin{matrix}T ( x , y , z , t + Δ t ) = T ( x , y , z , t ) + \\ {\sum }_{\begin{matrix}a = x - 1 , b = y , c = z \\ \begin{matrix}a = x + 1 , b = y , c = z \\ \begin{matrix}a = x , b = y - 1 , c = z \\ \begin{matrix}a = x , b = y + 1 , c = z \\ \begin{matrix}a = x , b = y , c = z - 1 \\ a = x , b = y , c = z + 1\end{matrix}\end{matrix}\end{matrix}\end{matrix}\end{matrix}} F ( a , b , c , x , y , z , t )\end{matrix} \qquad ( 0.2 )$$

and F(a,b,c,x,y,z) is defined as the temperature flow from cell (a,b,c) to cell (x,y,z) at time t as

$$\begin{matrix}F ( a , b , c , x , y , z , t ) = A ( a , b , c , x , y , z ) \times \\ ( T ( a , b , c , t ) - T ( x , y , z , t ) ) \times \\ TF ( a , b , c , x , y , z )\end{matrix} \qquad ( 0.3 )$$

A is the surface area of contact between cells (a,b,c) and (x,y,z). TF is a temperature change factor that varies based on whether the heat is being transferred through convection (contact of outer surface cell with the environment) or conduction (contact of two interior cells). It is defined as

$$\begin{matrix}TF ( a , b , c , x , y , z ) = {B}_{Convection} \times Δ t \} if cell a , b , c is outside the object ( Convection ) \\ = {B}_{Conduction} \times Δ t \} if cell a , b , c is inside the object ( Convection )\end{matrix}$$

B_{Convection} is the same as B defined above for non composite objects. B_{Conduction} is defined as

$${B}_{Conduction} = \frac{C / d}{mc} \qquad ( 0.4 )$$

where C is the thermal conductivity of the material and d is the length across which the temperature change occurs.

As an example, here are the values of this function for a 2×2×1 grid object of material type water with dimensions 1 meter per side. The initial object temperature T(a,b,c,0) is 100C and the ambient temperature Tₐ is 0C.

Above, we see the cell (1,1,0). Computing the values of the F function with Δt=60 seconds, we have the following

TABLE 1

| | Flow | | | | T(a,b,c,t)- | | TF | F(a,b,c, |
|---|---|---|---|---|---|---|---|---|
| Flow | Type | A(a,b,c) | T(a,b,c,0) | T(x,y,z,0) | T(x,y,z,t) | d | (a,b,c,x,y,z) | x,y,z) |
| Flow | Conduc- | .5 * 1 = .5 m² | 100 C | 100 C | 0 C | 1 | [(0.6 W/m-C/ | F(0,1,0,1,1,0, |
| from left | tion | | | | | | .5 m)/ | 60) = (.5 m²) * |
| | | | | | | | (250 kg * 4180 | (0 C) * 7.5005e−5/m²) = |
| | | | | | | | J/kg-C)] * 60 s = | 0.000 C |
| | | | | | | | 7.005e−5/m² | |
| Flow | Convec- | .5 * 1 = .5 m² | 0 C | 100 C | −100 C | 1 | [(5.0 W/m²C)/ | F(2,1,0,1,1,0,60) |
| from | tion | | | | | | (250 kg * 4180 | = (.5 m²) * |
| right | | | | | | | J/kg-C)] * 60 s = | (−100 C) * |
| | | | | | | | 2.871e−4/m² | 2.871e−4/m²) = |
| | | | | | | | | −0.014 C |
| Flow | Conduc- | .5 * 1 = .5 m² | 100 C | 100 C | 0 C | 1 | [(0.61 W/m-C/ | F(1,0,0,1,1,0, |
| from | tion | | | | | | .5 m)/ | 60) = (.5 m²) * |
| back | | | | | | | (250 kg * 4180 | (0 C) * |
| | | | | | | | J/kg-C)] * 60 s = | 7.5005e−5/m²) = |
| | | | | | | | 7.005e−5/m² | 0.000 C |
| Flow | Convec- | .5 * 1 = .5 m² | 0 C | 100 C | −100 C | 1 | [(5.0 W/m²C)/ | F(1,2,0,1,1,0, |
| from | tion | | | | | | (250 kg * 4180 | 60) = (.5 m²) * |
| front | | | | | | | J/kg-C)] * 60 s = | (−100 C) * |
| | | | | | | | 2.871e−4/m² | 2.871e−4/m²) = |
| | | | | | | | | −0.014 C |
| Flow | Convec- | .5 * .5 = .25 m² | 0 C | 100 C | −100 C | 1 | [(5.0 W/m²C)/ | F(1,1,−1,1,1, |
| from top | tion | | | | | | (250 kg * 4180 | 0,60) = (.25 m²) * |
| | | | | | | | J/kg-C)] * 60 s = | (−100 C) * |
| | | | | | | | 2.871e−4/m² | 2.871e−4/m²) = |
| | | | | | | | | −0.007 C |
| Flow | Convec- | .5 * .5 = .25 m² | 0 C | 100 C | −100 C | 1 | [(5.0 W/m²C)/ | F(1,1,1,1,1,0, |
| from | tion | | | | | | (250 kg * 4180 | 60) = (.25 m²) * |
| bottom | | | | | | | J/kg-C)] * 60 s = | (−100 C) * |
| | | | | | | | 2.871e−4/m² | 2.871e−4/m²) = |
| | | | | | | | | −0.007 C |

Thus, T(1,1,1,60)=T(1,1,1,0)+ΣF=99.958C. Where variables are as listed in Table 2.

TABLE 2

| Variable Name | Meaning |
|---|---|
| ObjTempGrid | Temperature grid of each of the cells of |
| | the object |
| TempGrid | Internal working copy of temperature grid |
| | of each of the cells of the object |
| Cols | Number of columns for the object (5) |
| Rows | Number of rows for the object (1 for row, |
| | 5 for grid) |
| Tₐ | Ambient Temperature |
| CellMass | Mass of each grid cell (object |
| | mass/number cells) |
| ObjSpecificHeat | Specific Heat of the Material |
| heatTransferCoefficient | Heat transfer coefficient |
| thermalConductivity | Thermal conductivity |
| Time | Time increment (60 s) |
| Bconvection | Internal variable for convection |
| BlengthConduction | Internal variable for conduction when it |
| | occurs lengthwise across a cell |
| TempFactorConductionLength | Internal variable for conduction when it |
| | occurs lengthwise across a cell |
| BwidthConduction | Internal variable for conduction when it |
| | occurs widthwise across a cell |
| TempFactorConductionWidth | Internal variable for conduction when it |
| | occurs widthwise across a cell |
| CellLength | Length of a cell |
| CellWidth | Width of a cell |

Algorithm Overview

1. Setup Variables

2. Compute new cell temperatures

Algorithm Details

1. Setup variables

a. Copy objTempGrid to tempGrid

b. BConvection=(heatTransferCoefficient)/(cellMass*objSpecificHeat)

c. tempFactorConvection=BConvection*time

d. BLengthConduction=cellLength/(cellMass*objSpecificHeat)

e. BWidthConduction=cellWidth/(cellMass*objSpecificHeat)

f. tempFactorConductionLength=BLengthConduction*time

g. tempFactorConductionWidth=BWidthConduction*time

h. leftRightContactArea=(width/cols)*height

i. frontBackContactArea=(length/rows)*height

j. topBottomContactArea=(width/cols)*(length/rows)

2. Compute new cell temperatures

a. For i=0 to cols-1

i. For j=0 to rows-1

1. leftTemp=(i==0) ? ambTemp:objTempGrid[I-1, j]

2. rightTemp=(i==cols-1) ? ambTemp:objTempGrid[i+1, j]

3. backTemp=(j==0) ? ambTemp:objTempGrid[i, j-1]

4. frontTemp=(j==rows-1) ? ambTemp:objTempGrid[i, j+1]

5. topTemp=ambTemp

6. bottomTemp=ambTemp

7. tempFactorLeft=(i==0) ? tempFactorConvection:tempFactorConductionLength

8. tempFactorRight=(i==cols-1) ? tempFactorConvection:tempFactorConductionLength

9. tempFactorBack=(j==0) ? tempFactorConvection:tempFactorConductionWidth

10. tempFactorFront=(j==rows-1) ? tempFactorConvection:tempFactorConductionWidth

11. tempFactorTop=tempFactorConvection

12. tempFactorBottom=tempFactorConvection

13. cellTemp=objTempGrid[i, j]

14. leftTempFlow=leftContactArea*(leftTemp−cellTemp)*tempFactorLeft

15. rightTempFlow=rightContactArea*(rightTemp−cellTemp)*tempFactorRight

16. backTempFlow=backContactArea*(backTemp−cellTemp)*tempFactorBack

17. frontTempFlow=frontContactArea*(frontTemp−cellTemp)*tempFactorFront

18. topTempFlow=topContactArea*(topTemp−cellTemp)*tempFactorTop

19. bottomTempFlow=bottomContactArea*(bottomTemp−cellTemp)*tempFactorBottom

20. tempGrid[I, j]=cellTemp+leftTempFlow+rightTempFlow+backTempFlow+frontTempFlow+topTempFlow+bottomTempFlow

b. For i=0 to cols-1

i. For j=0 to rows-1

1. objTempGrid [i, j]=tempGrid [i, j]

Input Parameters

When the program is executed, it will check to see if the list HTINI is present. The program will then set the values as described by the List Setup table, using the default values if the HTINI list is not present. Upon program exit, the current values of these parameters are stored back into the HTINI list.

TABLE 3
List Setup

| | | List | Default |
|---|---|---|---|
| Parameter | Range | Element | Value |
| Ambient Temperature | 0.0. . .100.0 C | 1 | 100 |
| Object Material | 0 => Aluminum | 2 | Wood |
| | 1 => Iron | | |
| | 2 => Water | | |
| | 3 => Nickel | | |
| 4 => Silver | | | |
| 5 => Sodium | | | |
| | 6 => Copper | | |
| | 7 => Glass | | |
| | 8 => Gold | | |
| | 9 => Lead | | |
| | 10 => Marble | | |
| | 11 => Wood | | |
| | 12 => Mammal | | |
| | 13 => Bones | | |
| ObjectType | 0 => Box | 3 | 0 |
| | 1 => Cylinder | | |
| | 2 => Sphere | | |
| | 3 => Row | | |
| | 4 => Grid | | |
| Object Size Dimension 1 | Length | 4 | .2 m |
| Length (Box, Row, Grid) | 0.0. . .4.0 m Dia. | | |
| Diameter (Sphere, Cylinder) | 0.0. . .2.0 m | | |
| Object Size Dimension 2 | Width | 5 | .2 m |
| Width (Box, Row, Grid) | 0.0. . .4.0 m | | |
| Height (Cylinder) | Height | | |
| | 0.0. . .2.0 m | | |
| Object Size Dimension 3 | Height | 6 | .2 m |
| Height (Box, Row, Grid) | 0.0. . .2.0 m | | |
| Object Size Dimension 4 | | 7 | |
| For Future Use | | | |
| Object (Cell) Temperature | 0.0. . .100.0 | 8. . .32 | 0.0 |
| Object (Cell) Heat Source | 0 (no) 1 (yes) | 33. . .57 | 0 |

Other Embodiments

Although the present invention has been described in detail, it should be understood that various changes, substitutions, and alterations could be made hereto without departing from the spirit and scope of the invention as defined by the appended claims.

The described embodiment of the present invention is an application program on a graphing calculator, which allows the user observe a grid of real-time data and allows the user to easily make changes in the grid data while the program is operating. Similarly, other embodiments include the same user interface functionality in a ROM software application package that is executed on a graphing calculator or other handheld device.

What is claimed is:

1. A software program stored on a computer media for a handheld computer device which provides a user interface for the computer device comprising:
a display grid having rows and columns of cells;
a number displayed in a plurality of the cells, and
wherein the numbers displayed in the cells are updated under software control and represent a common quantity which changes according to an algorithm set by a user.

2. The software program of claim 1, further comprising a cursor operable by the user, which indicates at least one currently selected cell.

3. The software program of claim 2, wherein the cursor is a dashed cell outline.

4. The software program of claim 1, further comprising an input to allow the user to set at least one cell to a fixed value.

5. The software program claim 1, further comprising an input to allow the user to adjust the value of a cursor selected cell up or down while the software is changing the numbers displayed in the cells according to the algorithm preset by the user.

6. The software program of claim 1, further comprising:
a. an input to allow the user to set at least one cell to a fixed value, and
b. a dashed cell outline cursor operable by the user, which indicates at least one currently selected cell.

7. The software program of claim 6, further comprising an input to allow the user to adjust the value of a cursor selected cell up or down while the software is changing the numbers displayed in the cells according to the algorithm preset by the user.

8. The software program of claim 7, wherein the software is programmed to provide a heat transfer lab simulation environment for a handheld device.

9. A handheld computing device comprising:
a display screen;
an input device for operating the computing device and entering user responses;
a processor for executing programming that provides a user interface to the spreadsheet application wherein the user interface further comprises:
a display grid having rows and columns of cells;
a cursor operable by user input through the input device, wherein the cursor indicates at least one currently selected cell; and
a number displayed in a plurality of the cells, and
wherein the numbers displayed in the cells are updated under software control and represent a common quantity which changes according to an algorithm set by a user.

10. The handheld computing device of claim 9, further comprising a cursor operable by the user, which indicates at least one currently selected cell.

11. The handheld computing device of claim 10, wherein the cursor is a dashed cell outline.

12. The handheld computing device of claim 9, further comprising an input to allow the user to set at least one cell to a fixed value.

13. The handheld computing device of claim 9, further comprising an input to allow the user to adjust the value of a cursor selected cell up or down while the software is changing the numbers displayed in the cells according to the algorithm preset by the user.

14. The handheld computing device of claim 9, further comprising:
an input to allow the user to set at least one cell to a fixed value, and
a dashed cell outline cursor operable by the user, which indicates at least one currently selected cell.

15. The handheld computing device of claim 14, further comprising an input to allow the user to adjust the value of a cursor selected cell up or down while the software is changing the numbers displayed in the cells according to the algorithm preset by the user.

16. A graphing calculator comprising:
a screen capable of displaying spreadsheet rows and columns for a spreadsheet application;
an input device for operating the computing device and entering user responses;
a processor for executing programming that provides a user interface to the spreadsheet application wherein the user interface further comprises:
a display grid having rows and columns of cells;
a cursor operable by user input through the input device, wherein the cursor indicates at least one currently selected cell; and
a number displayed in a plurality of the cells, and
wherein the numbers displayed in the cells are updated under software control and represent a common quantity which changes according to an algorithm set by a user.
